(19) United States
(12) Patent Application Publication
(10) Pub. No.: US 2013/0286360 A1
(43) Pub. Date: Oct. 31, 2013

(54) PROJECTOR

(71) Applicant: SEIKO EPSON CORPORATION, Tokyo (JP)

(72) Inventors: Masakazu KAWAMURA, Matsumoto-shi (JP); Kanji YOSHIDA, Azumino-shi (JP); Akira HASHIMOTO, Shiojiri-shi (JP); Takayuki MATSUBARA, Chino-shi (JP)

(73) Assignee: SEIKO EPSON CORPORATION, Tokyo (JP)

(21) Appl. No.: 13/860,950

(22) Filed: Apr. 11, 2013

(30) Foreign Application Priority Data
Apr. 25, 2012 (JP) 2012-099992

(51) Int. Cl. G03B 21/28

(52) U.S. Cl. CPC G03B 21/28
USPC 353/33; 353/31

(57) ABSTRACT

Even when coherent light (specific light), such as laser light, is used as a light source, providing a first dichroic film having a seamless, single-film configuration as a film in a cross dichroic prism prevents a fringe pattern resulting from a highly interfering component contained in light combined in the cross dichroic prism from being produced, whereby the amount of image degradation can be reduced.

### BACKGROUND

1. Technical Field

The present invention relates to a projector including a laser light source or any other light source that produces interfering light, light that causes interference, to form a color image that is a combination of images of different colors.

2. Related Art

There is a known projection-type display apparatus, such as a projector, including a cross dichroic prism to form a color image (see JP-A-2002-189109, JP-A-2007-58008, and JP-A-11-352440, for example). It is also known in a projector using a cross dichroic prism that one of the dichroic films therein has a single-film configuration (see JP-A-2002-189109, JP-A-2007-58008, and JP-A-11-352440).

On the other hand, there is a known projector that uses laser light as a light source (see JP-A-2007-33578 and JP-A-2011-128482, for example). In JP-A-2007-33578, for example, a diffuser optical element is used to diffuse the laser light to form uniform illumination light for illumination, and in JP-A-2011-128482, a fluorescent member is used to convert the laser light, which works as excitation light, into fluorescence that is then used as illumination light.

When the cross dichroic prism described, for example, in JP-A-2002-189109 is used to combine images, however, at least one of the dichroic films in the cross dichroic prism has a seam at the intersection where the dichroic films cross each other. In this case, when interfering light, such as laser light, is used as a light source as described, for example, in JP-A-2007-33578, interference occurs at the seam where the dichroic films cross each other, and a fringe pattern conceivably resulting from the interference appears on a screen or any other irradiated surface. Depending on a projection environment, such a pattern is highly visible, resulting in image degradation in some cases.

### SUMMARY

An advantage of some aspects of the invention is to provide a projector that combines color light fluxes to form a color image with a suppressed amount of image degradation, for example, resulting from light produced by a solid-state light source, such as coherent laser light, used as a light source of the projector.

A projector according to an aspect of the invention includes a light source apparatus that includes at least one solid-state light source and outputs illumination light formed of first light that is produced by the at least one solid-state light source and contains specific light as a component and second light that is produced by the at least one solid-state light source but does not contain the specific light as a component, a light modulation unit including a first light modulator that modulates the first light contained in the illumination light from the light source apparatus in accordance with image information and a second light modulator that modulates the second light contained in the illumination light from the light source apparatus in accordance with image information, a light combining system that combines modulated light fluxes from the light modulation unit, and a projection system that projects the combined light from the light combining system as a projected image, wherein the specific light produced by the at least one solid-state light source is coherent light, and the light combining system has a specific dichroic film having a single-film, continuous film structure provided in correspondence with the first light. A conceivable example of the specific light, which is coherent light, produced by the solid-state light source includes particularly highly interfering light, for example, laser light. Laser light is a light component that can cause image degradation due, for example, to interference, such as generation of a fringe pattern on a screen.

According to the projector described above, one of the components modulated by the light modulation unit, the first light containing the specific light, which is coherent light, produced by the solid-state light source is combined with the other modulated light component when the two components experiences passage at the single, continuous, seamless specific dichroic film in the light combining system. The passage at the specific dichroic film is not limited, for example, to transmissive passage but includes reflective passage. As a result, no fringe pattern is produced on a screen or any other irradiated surface due to the highly interfering specific light, whereby the amount of image degradation can be reduced.

In a specific aspect or a specific viewpoint of the invention, the at least one solid-state light source is a laser light source that produces laser light as the specific light. In this case, using the laser light source allows formation of high intensity illumination light.

In another viewpoint of the invention, in the light combining system, the specific dichroic film reflects the first light and transmits the second light to combine the first light and the second light with each other. In this case, the specific dichroic film deflects the first light containing the specific light, whereas transmitting the second light containing no specific light to combine the two types of light with each other.

In still another viewpoint of the invention, the light source apparatus outputs third light different from the first and second light as the illumination light, the projector further includes a color separation/light guiding system that separates the second light and the third light from each other, the light modulation unit further includes a third light modulator corresponding to the third light, and the light combining system is a cross dichroic prism that combines the first, second, and third light modulated by the first, second, and third light modulators, respectively. In this case, a color image formed by the three color light fluxes, the first light to the third light, can be formed.

In still another viewpoint of the invention, the light source apparatus includes a first light source unit and a second light source unit, the first light source unit includes a first light source section that produces the specific light and a diffuser member that diffuses the specific light from the first light source section to form the first light within a first wavelength band, and the second light source unit includes a second light source section that produces excitation light and a fluorescent member that is irradiated with the excitation light from the second light source section and converts the excitation light into fluorescence within a second wavelength band to which at least the second light belongs. In this case, the diffuser member can appropriately diffuse the first light containing the specific light, whereas the fluorescent member can convert the excitation light to form fluorescence containing no specific light but containing the second light.

In still another viewpoint of the invention, in the light source apparatus, the first wavelength band is formed of wavelengths shorter than wavelengths in the second wavelength band. In this case, color light within the second wavelength band, which is formed of wavelengths longer than those in the first wavelength band, is produced by the conversion performed by the fluorescent member, the color light can be combined with the color light within the first wavelength band to form a color image.

In still another viewpoint of the invention, in the first light source unit, the first wavelength band is a blue light wavelength band, and in the second light source unit, the second wavelength band is a yellow light wavelength band. In this case, the blue light, which is the first light, and the yellow light, which contains the second light, can form a color image.

In still another viewpoint of the invention, in the second light source unit, the excitation light is one of blue light, violet light, and ultraviolet light. In this case, the excitation light can be converted, for example, into color light necessary to form a color image.

In still another viewpoint of the invention, the diffuser member has a first light diffusing portion on a light incident surface side and a second light diffusing portion on a light exiting surface side. In this case, the degree of diffusion can be increased to reduce the degree of an effect of optical interference.

### BRIEF DESCRIPTION OF THE DRAWINGS

The invention will be described with reference to the accompanying drawings, wherein like numbers reference like elements.

FIG. 1 describes the optical system of a projector according to an embodiment.

FIG. 2 is a partial enlarged view of a light combining system and therearound in the projector.

FIG. 3A is a partial enlarged view of a light combining system and therearound in Comparative Example, and FIG. 3B describes a phenomenon that can occur in Comparative Example.

FIG. 4 describes the optical system of a light source unit in a projector according to a variation.

### DESCRIPTION OF EXEMPLARY EMBODIMENTS

A projector according to an embodiment of the invention will be described below in detail with reference to the drawings.

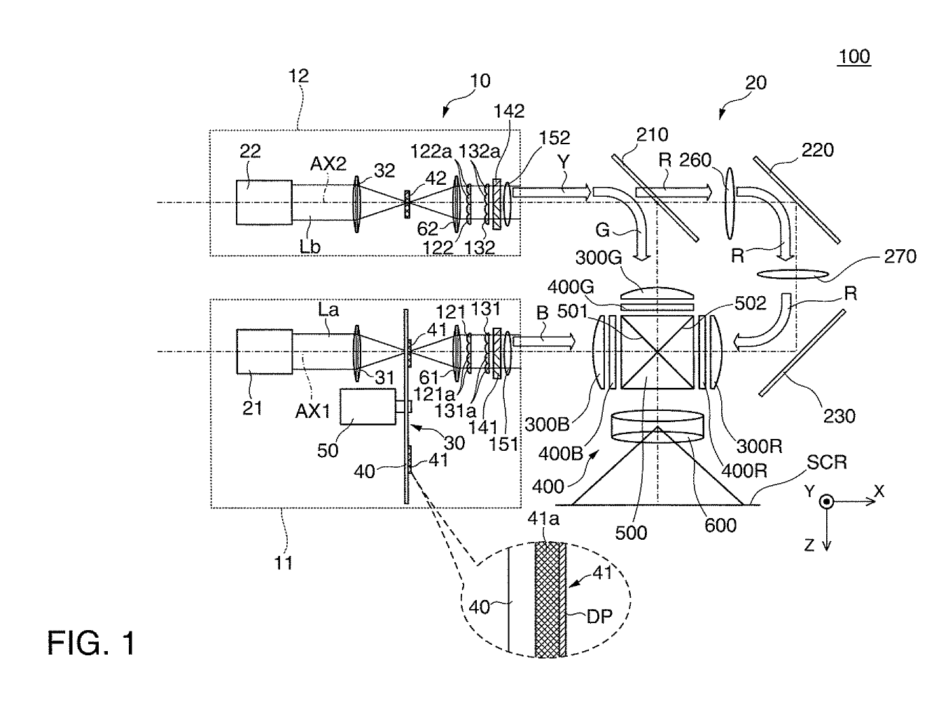

A projector 100 shown in FIG. 1 includes a light source apparatus 10, a color separation/light guiding system 20, a light modulation unit 400, a cross dichroic prism 500, which is a light combining system, and a projection system 600. In the projector 100, field lenses 300R, 300G, and 300B are disposed between the color separation/light guiding system 20 and the light modulation unit 400.

The light source apparatus 10 is formed of two light source units, a first light source unit 11 and a second light source unit 12, each of which outputs illumination light. The first light source unit 11, as part of the light source apparatus 10, outputs blue light as first light that contains part of the entire wavelength components of the illumination light. Similarly, the second light source unit 12, as part of the light source apparatus 10, outputs yellow light containing red light and green light as the remaining wavelength components of the illumination light. That is, the light source apparatus 10 as a whole outputs illumination light from which blue, green, and red three color light fluxes can be formed. One of the components contained in the yellow light outputted from the second light source unit 12, the green light, is called second light, and the other one of the components, the red light, is called third light.

In the light source apparatus 10, the first light source unit 11 will be described below in detail. The first light source unit 11 includes a first light source section 21, a collector lens 31, which is a light collection system, a diffuser member 41, a rotating mechanism 30, a collimation system 61, a first lens array 121, a second lens array 131, a polarization conversion element 141, and a superimposing lens 151.

In the first light source unit 11, the first light source section 21 is a solid-state light source, specifically, a laser light source that emits blue laser light La. The laser light La has a peak light emission intensity, for example, at about 445 nm, and primary components of the laser light La belong to a wavelength band ranging from 430 to 450 nm (first wavelength band). In other words, the first wavelength band, which is the wavelength range of the laser light La, is a blue light wavelength band.

The laser light La is highly interfering light, that is, coherent light, and the laser light La is used as specific light. Highly interfering light, the laser light La in this case, is used as the illumination light.

The collector lens 31 collects the laser light La emitted from the first light source section 21 into a substantially collected state and delivers the substantially collected laser light La to the diffuser member 41.

The rotating mechanism 30 includes a light-transmissive circular plate 40, which supports the diffuser member 41, and a motor 50, which rotates the circular plate 40. The circular plate 40 is made, for example, of crystal glass, quartz, sapphire, optical glass, a transparent resin, or any other suitable transparent material and transmits the laser light La.

The diffuser member 41 is a ring-shaped plate member continuously formed along the direction in which the circular plate 40 is rotated so that the diffuser member 41 covers the area of the circular plate 40 on which the laser light La is incident. The diffuser member 41, as shown in a partial enlarged view thereof, has a body member 41a and a light diffusing portion DP having an irregular surface and disposed on the side of the body member 41a that faces away from the circular plate 40, that is, on the light-exiting side. The thus configured diffuser member 41 appropriately diffuses the laser light La incident thereon.

The rotating mechanism 30 outputs blue light B, which is the first light produced from the laser light La diffused by the diffuser member 41, through the side opposite the side on which the laser light La is incident, while rotating the circular plate 40, for example, at 7500 rpm when the projector 100 is used to prevent the temperature of the diffuser member 41 from increasing.

The collimation system 61 substantially parallelizes the blue light B, which is divergent light having exited out of the diffuser member 41 on the rotating mechanism 30.

The first lens array 121 functions as a light flux dividing optical element that includes a plurality of first lenslets 121a and divides the light having passed through the collimation system 61 into a plurality of sub-light fluxes. The first lenslets 121a are arranged in a matrix formed of a plurality of rows and columns in a plane perpendicular to an optical axis AX1. Although not illustratively described, the outer shape of each of the first lenslets 121a is substantially similar to the outer shape of an image formation area of a liquid crystal light modulator 400B, which is a light modulating device.

The second lens array 131 includes a plurality of second lenslets 131a corresponding to the plurality of first lenslets 121a in the first lens array 121. The second lens array 131 along with the superimposing lens 151 has a function of focusing an image of each of the first lenslets 121a in the first lens array 121 in a position in the vicinity of the image formation area of the liquid crystal light modulator 400B.

The polarization conversion element 141 is an optical element that converts the divided sub-light fluxes from the first lens array 121 into substantially one type of linearly polarized sub-light fluxes having a single aligned polarization direction and outputs the linearly polarized sub-light fluxes. The polarization conversion element 141 includes a polarization separation layer that transmits one of the linearly polarized components contained in the light from the diffuser member 41 and reflects another one of the linearly polarized components in a direction perpendicular to the optical axis AX1, a reflection layer that reflects the other linearly polarized component reflected off the polarization separation layer in the direction parallel to the optical axis AX1, and a wave plate that converts the other linearly polarized component reflected off the reflection layer into the one linearly polarized component.

The superimposing lens 151 is an optical element that collects the sub-light fluxes from the polarization conversion element 141 and superimposes them in a position in the vicinity of the image formation area of the liquid crystal light modulator 400B. The first lens array 121, the second lens array 131, and the superimposing lens 151 form an optical integration system that makes the in-plane light intensity distribution of the blue light B, which is laser light, uniform and make the in-plane illuminance of the blue light B from the diffuser member 41 uniform in the vicinity of the image formation area.

The thus configured first light source unit 11, as part of the light source apparatus 10, outputs the blue light B, which is a component of the illumination light, as the first light toward the light modulation unit 400. The blue light B contains a laser light component, that is, a highly interfering light component.

The second light source unit 12 in the light source apparatus 10 will next be described in detail. The second light source unit 12 includes a second light source section 22, a collector lens 32, which is a light collection system, a fluorescent member 42, a collimation system 62, a first lens array 122, a second lens array 132, a polarization conversion element 142, and a superimposing lens 152.

In the second light source unit 12, the second light source section 22 is a solid-state light source, specifically, a laser light source that emits blue laser light Lb, which is excitation light. The laser light Lb has a peak light emission intensity, for example, at about 445 nm.

The collector lens 32 collects the laser light Lb emitted from the second light source section 22 into a substantially collected state and delivers the substantially collected laser light Lb to the fluorescent member 42.

The fluorescent member 42 is formed of a layer containing, for example, (Y,Gd)₃(Al,Ga)₅O₁₂:Ce, which is a YAG-based fluorescent member, and converts the laser light Lb (blue light) emitted as the excitation light from the second light source section 22 into light containing red light and green light. That is, the fluorescent member 42 is a wavelength conversion element that converts the laser light Lb into fluorescence having components that belong to another wavelength range (second wavelength band). Specifically, the fluorescent member 42 is efficiently excited by the laser light Lb, which is excitation light having the wavelength of 445 nm, and converts the laser light Lb (excitation light) emitted from the second light source section 22 into yellow light Y, which is fluorescence containing red light and green light. That is, the fluorescent member 42 converts the excitation light, which is blue light, into light within the second wavelength band, which is a yellow light wavelength band. Further, the fluorescent member 42 converts relatively high interfering laser light into relatively low interfering fluorescence. Shorter-wavelength components of the yellow light Y, which is fluorescence, are used as the green light (second light), and longer-wavelength components of the yellow light Y are used as the red light (third light). If part of the laser light Lb is not converted by the fluorescent member 42 but is left as it is, the unconverted laser light Lb can be removed out of the optical path, for example, by using a dichroic mirror (not shown). Further, in the above description, the first wavelength band to which the first light (blue light) belongs is formed of wavelengths shorter than those in the second wavelength band to which the second and third light (yellow light) belongs.

The fluorescent member 42 outputs the yellow light Y, which is the fluorescence produced from the converted laser light Lb, through the side opposite the side on which the laser light Lb is incident.

The collimation system 62 substantially parallelizes the yellow light Y, which is divergent light having exited out of the fluorescent member 42.

The first lens array 122 functions as a light flux dividing optical element that includes a plurality of first lenslets 122a and divides the light having passed through the collimation system 62 into a plurality of sub-light fluxes. The first lenslets 122a are arranged in a matrix formed of a plurality of rows and columns in a plane perpendicular to an optical axis AX2. Although not illustratively described, the outer shape of each of the first lenslets 122a is substantially similar to the outer shape of image formation areas of liquid crystal light modulators 400G and 400R, each of which is a light modulating device.

The second lens array 132 includes a plurality of second lenslets 132a corresponding to the plurality of first lenslets 122a in the first lens array 122. The second lens array 132 along with the superimposing lens 152 has a function of focusing an image of each of the first lenslets 122a in the first lens array 122 in a position in the vicinity of the image formation area of each of the liquid crystal light modulators 400G and 400R.

The polarization conversion element 142 is an optical element that converts the divided sub-light fluxes from the first lens array 122 into substantially one type of linearly polarized sub-light fluxes having a single aligned polarization direction and outputs the linearly polarized sub-light fluxes. The polarization conversion element 142 includes a polarization separation layer that transmits one of the linearly polarized components contained in the light from the fluorescent member 42 and reflects another one of the linearly polarized components in a direction perpendicular to the optical axis AX2, a reflection layer that reflects the other linearly polarized component reflected off the polarization separation layer in the direction parallel to the optical axis AX2, and a wave plate that converts the other linearly polarized component reflected off the reflection layer into the one linearly polarized component.

The superimposing lens 152 is an optical element that collects the sub-light fluxes from the polarization conversion element 142 and superimposes them in a position in the vicinity of the image formation area of each of the liquid crystal light modulators 400G and 400R. The first lens array 122, the second lens array 132, and the superimposing lens 152 form an optical integration system that makes the in-plane light intensity distribution of the yellow light Y, which is fluorescence, uniform and make the in-plane illuminance of the yellow light Y from the fluorescent member 42 uniform in the vicinity of the image formation areas.

The thus configured second light source unit 12, as part of the light source apparatus 10, outputs the yellow light Y, which is a component of the illumination light, toward the color separation/light guiding system 20 provided in a position upstream of the light modulation unit 400. The yellow light Y is fluorescence produced from the converted laser light Lb and contains no highly interfering light component, such as the laser light La (specific light) produced by the first light source section 21 in the first light source unit 11. Instead, the yellow light Y contains green light G and red light R as color light components. The green light G is called the second light and the red light R is called the third light, as described above. That is, the second light source unit 12 outputs the yellow light Y containing the second and third light as part of the illumination light.

In the second light source unit 12 described above, the fluorescent member 42 and the components therearound may be so configured that a circular-plate-shaped rotating mechanism 30 is provided to hold a ring-shaped fluorescent member 42 in a rotatable manner, as in the first light source unit 11.

A description will be made how the color separation/light guiding system 20 separates the yellow light Y, which is the fluorescence outputted from the second light source unit 12, into constituent color light fluxes and guides the separated color light fluxes. The color separation/light guiding system 20 has a function of separating the yellow light Y, which is outputted from the second light source unit 12 in the light source apparatus 10, into the green light G, which is the second light, and the red light R, which is the third light, and guiding the green light G and the red light R to the liquid crystal light modulators 400G and 400R, which are illuminated with the color light fluxes G and R, in the light modulation unit 400. The color separation/light guiding system 20 includes a dichroic mirror 210, reflection mirrors 220 and 230, and relay lenses 260 and 270. The field lenses 300R and 300G are disposed between the color separation/light guiding system 20 and the liquid crystal light modulators 400G and 400R, which form the light modulation unit 400, as described above.

The dichroic mirror 210 is a mirror formed by forming a wavelength selective, transmissive film that reflects light within a predetermined wavelength region and transmits light within the remaining wavelength range on a substrate. The dichroic mirror 210 reflects the green light component and transmits the red light component in this case. The reflection mirrors 220 and 230 are mirrors that reflect the red light component. The thus configured dichroic mirror 210 separates the yellow light Y incident thereon into the green light G, which is the second light, and the red light R, which is the third light.

The green light G, which is one of the components of the yellow light Y, is reflected off the dichroic mirror 210, passes through the field lens 300G, and impinges on the image formation area of the liquid crystal light modulator 400G for green light.

The red light R, which is the other one of the components of the yellow light Y, passes through the dichroic mirror 210, travels via the relay lens 260, the light incident-side reflection mirror 220, the relay lens 270, and the light exiting-side reflection mirror 230, further passes through the field lens 300R, and impinges on the image formation area of the liquid crystal light modulator 400R for red light. That is, the relay lenses 260 and 270 and the reflection mirrors 220 and 230 function as a relay system that guides the red light component having passed through the dichroic mirror 210 to the liquid crystal light modulator 400R.

On the other hand, the blue light B, which is the first light, does not pass through the color separation/light guiding system 20 but directly passes through the field lens 300B and impinges on the image formation area of the liquid crystal light modulator 400B for blue light. The length of the optical path of the blue light B may be adjusted in correspondence with those of the green light G and the red light R or may be adjusted by using a relay system.

The light modulation unit 400 is formed of the liquid crystal light modulators 400R, 400G, and 400B, and the liquid crystal light modulators 400R, 400G, and 400B are each a light modulating device that modulates color light incident thereon in accordance with image information to form a color image. Specifically, the three liquid crystal light modulators operate as follows: The liquid crystal light modulator 400B, which is a first light modulator, modulates the blue light B (first light) from the first light source unit 11; the liquid crystal light modulator 400G, which is a second light modulator, modulates the green light G (second light), which is one part of the yellow light Y from the second light source unit 12; and the liquid crystal light modulator 400R, which is a third light modulator, modulates the red light R (third light), which is the other part of the yellow light Y from the second light source unit 12. Although not shown, the liquid crystal light modulators 400R, 400G, and 400E are accompanied by light incident-side polarizers disposed on the side where the field lenses 300R, 300G, and 300B are present and light exiting-side polarizers disposed on the side where the cross dichroic prism 500 is present, and a liquid crystal panel, which is a primary portion that performs modulation operation according to an image signal, is disposed between each pair of the light incident-side polarizers and the light exiting-side polarizers. Each set of the light incident-side polarizer, the liquid crystal panel, and the light exiting-side polarizer performs optical modulation on incident color light.

The liquid crystal panel that forms the primary portion of each of the liquid crystal light modulators 400R, 400G, and 400B is a transmissive light modulating device that seals and encapsulates a liquid crystal material, which is an electro-optic substance, between a pair of transparent glass substrates. In each of the liquid crystal light modulators 400R, 400G, and 400B, for example, a polysilicon TFT is provided as a switching device to modulate the polarization direction of the one type of linearly polarized light having exited out of the corresponding light incident-side polarizer in accordance with a provided image signal.

The cross dichroic prism 500, which is a light combining system, is an optical element that combines the modulated color light fluxes having exited out of the light exiting-side polarizers to form a color image. The cross dichroic prism 500 is formed by bonding four rectangular prisms and thus has a substantially square shape in a plan view. A pair of first and second dichroic films 501, 502, each of which is a dielectric multilayer film, are formed along the substantially X-shaped interfaces between the bonded rectangular prisms. The dichroic films 501 and 502 have characteristics different from each other; the first dichroic film 501 formed on one of the substantially X-shaped interfaces is a dielectric multilayer film that allows transmissive passage of the red light R and the green light G and allows reflective passage of the blue light B, and the second dichroic film 502 formed on the other interface is a dielectric multilayer film that allows transmissive passage of the green light G and the blue light B and allows reflective passage of the red light R.

The light having exited out of the cross dichroic prism 500 is enlarged and projected through the projection system 600 and forms a color image on a screen SCR.

In the present embodiment, a first dichroic film 501, which reflects the modulated blue light B, which is highly interfering laser light, has a seamless, single-film, continuous film structure. The thus configured first dichroic film 501 is called a specific dichroic film in the description. Since the dichroic film 501, which is a specific dichroic film, has, for example, no slit-like seam, the dichroic film 501 will not produce a fringe pattern or any other similar pattern on the screen resulting from the blue light B, which is highly interfering light, that is, coherent light.

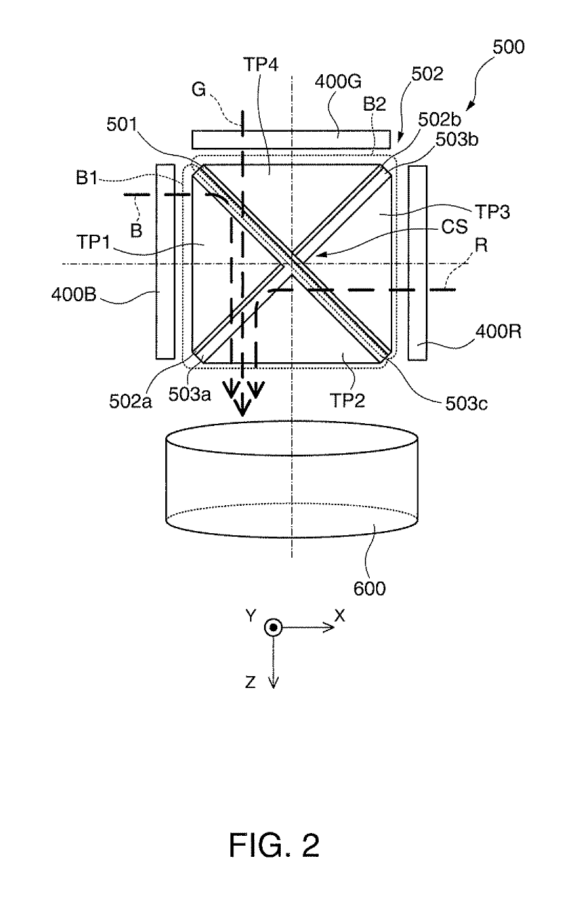

The structure of the cross dichroic prism 500 will be described below in detail with reference to FIG. 2. The cross dichroic prism 500 has the first dichroic film 501 and the second dichroic film 502 and further has the four rectangular prisms TP1 to TP4, as described above. The first dichroic film 501 has a seamless, single-film configuration as described above, whereas the second dichroic film 502 is formed of a pair of two dichroic film portions 502a and 502b with a seam at an intersection CS where the two dichroic films intersect each other. The cross dichroic prism 500 is so formed that the first dichroic film 501 and the second dichroic film 502 are sandwiched between the four rectangular prisms TP1 to TP4 via adhesive layers 503a to 503c.

A more specific description will be made of the cross dichroic prism 500 from the viewpoint of production. Among the rectangular prisms TP1 to TP4, first consider how to bond the rectangular prism TP1, which forms a surface on which the blue light B is incident, to the rectangular prism TP2, which forms a surface through which light exits toward the projection system 600. The dichroic film portion 502a for reflecting the red light R is formed in an evaporation process on the surface of the rectangular prism TP1 that is bonded to the rectangular prism TP2, and the rectangular prisms TP1 and TP2 are bonded with the adhesive layer 503a to each other with the dichroic film portion 502a sandwiched therebetween. A first block B1 is thus produced. Similarly, a second block B2 is produced by bonding the rectangular prism TP3, which forms a surface on which the red light R is incident, and the rectangular prism TP4, which forms a surface on which the green light G is incident, with the adhesive layer 503b to each other with the dichroic film portion 502b for reflecting the red light R sandwiched therebetween. Finally, before the first block B1 and the second block B2 are bonded to each other, the seamless first dichroic film 501 having the single-film configuration for reflecting the blue light B is formed in an evaporation process on the surface of the second block B2 that is bonded to the first block B1, and then the first block B1 and the second block 32 are bonded with the adhesive layer 503c to each other with the first dichroic film 501 sandwiched therebetween. The cross dichroic prism 500 is thus produced.

In the configuration described above, consider the red light R and the blue light B, which are reflected off the dichroic films in the cross dichroic prism 500 and combined with the other color light. The red light R, which is fluorescence, is reflected off the second dichroic film 502 having the two-film configuration having a seam at the central intersection CS. On the other hand, the blue light B, which is laser light, is reflected off the first dichroic film 501 having the single-film configuration having no seam at the central intersection CS. As a result, the projected color image light can form an image having a reduced amount of degradation because no fringe pattern is produced on the screen SCR, which is an irradiated surface.

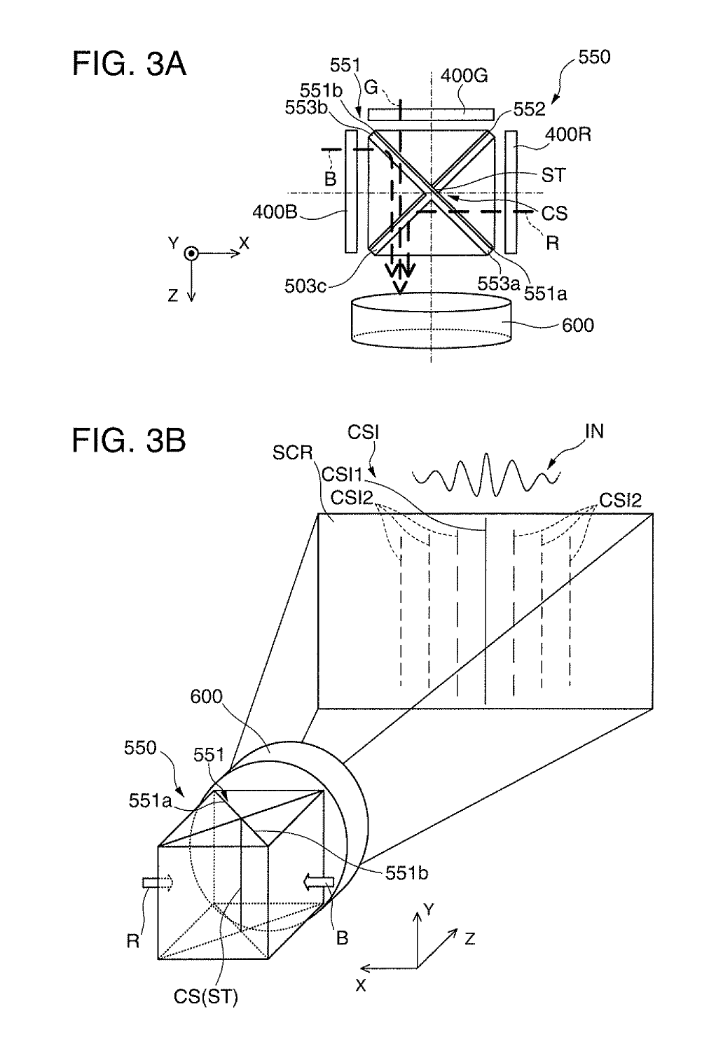

FIG. 3A shows a cross dichroic prism according to Comparative Example, and FIG. 3B diagrammatically shows a fringe pattern produced on the screen SCR when the cross dichroic prism according to Comparative Example is used.

In a cross dichroic prism 550 according to Comparative Example shown in FIG. 3A, a first dichroic film 551, which reflects the blue light B, which is laser light, is formed of a pair of two dichroic film potions 551a and 551b, and a second dichroic film 552, which reflects the red light R, which is not laser light, has a seamless, single-film configuration. That is, an inter-film portion ST, which does not reflect the blue light B, is present at the intersection CS. In this case, a fringe pattern CSI is disadvantageously produced on the screen SCR in accordance with the size of the inter-film portion ST at the intersection CS and the wavelength of the blue light B, as shown in FIG. 3B. Specifically, the most visible vertical slit CSI1 is produced in a central portion of the screen SCR in accordance with the shape of the intersection CS (inter-film portion ST), and a plurality of vertical slits CSI2 are periodically produced on the right and left sides of the slit CSI1. A conceivable reason for this is, for example, that the blue light B, which is laser light and highly interfering light (coherent light), produces components that interfere with each other in periodically constructive and destructive manner, as indicated by a wavy line IN. In contrast, in the present embodiment, since the first dichroic film 501, which reflects the blue light B, is a specific dichroic film, that is, has a seamless, single-film, continuous film structure as described above, no fringe pattern is produced on the screen SCR.

As described above, according to the projector 100 having the configuration described above, which includes the first dichroic film 501 having the seamless, single-film configuration as a film in the cross dichroic prism 500, a fringe pattern resulting from a highly interfering component contained in the light combined in the cross dichroic prism 500 is not produced even when coherent light, such as laser light, is used as a light source, that is, even when the illumination light contains coherent light, whereby the amount of image degradation can be reduced. In the present embodiment, although the second dichroic film 502, which reflects the red light R, is formed of the pair of two dichroic film portions 502a and 502b, and has a seam at the central intersection CS as shown in FIG. 2, the seam produces no fringe pattern because the red light R is fluorescence, which is not highly interfering.

It is assumed in the above description that the yellow light Y outputted from the second light source unit 12 contains the green light G as the second light and the red light R as the third light. Conversely, the red light R and the green light G contained in the yellow light Y may be the second light and the third light, respectively.

### Others

The invention has been described with reference to the above embodiment, but the invention is not limited thereto. The invention can be implemented in a variety of other aspects to the extent that they do not depart from the substance of the invention. For example, the following variations are conceivable.

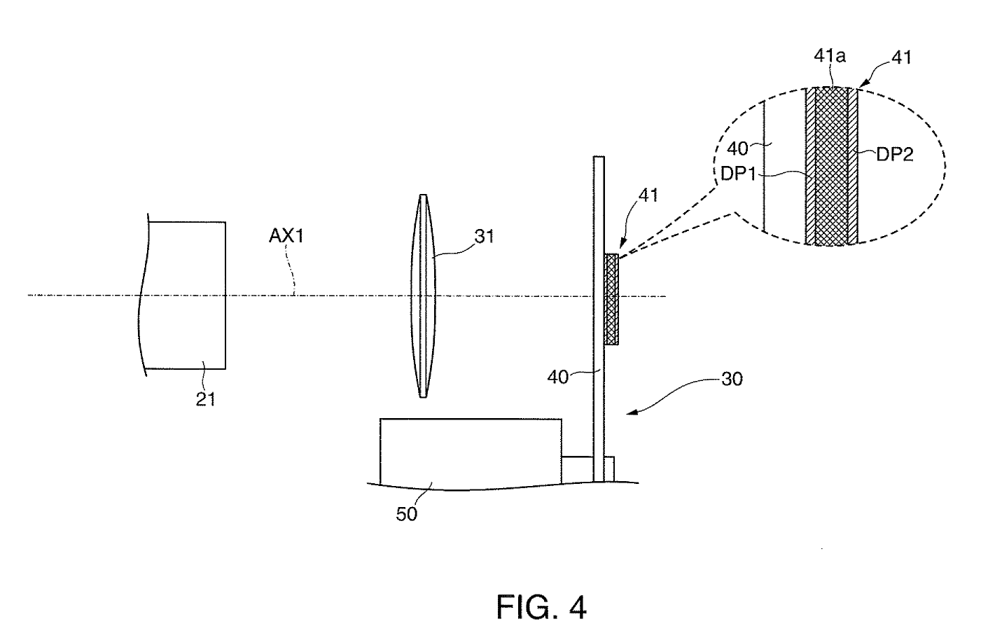

For example, in the above description, the diffuser member 41 is so configured that the light diffusing portion DP having an irregular surface is present only on the side of the body member 41a that faces away from the circular plate 40, that is, on the light-exiting side. Alternatively, a first light diffusing portion DP1 may be provided on the body member 41a on the side close to the circular plate 40, that is, on the light-incident side, and a second light diffusing portion DP2 may be provided on the body member 41a on the side facing away from the circular plate 40, that is, on the light-exiting side, as shown, for example, in a partial enlarged inset view in FIG. 4. In this case, the laser light is diffused by a greater amount, whereby a fringe pattern is more unlikely to be produced on the screen SCR (see FIG. 1).

Further, in the above description, the first light containing specific light is blue light on the shortest wavelength side in the visible region. Alternatively, light of another color may be used as the first light. That is, green light or red light may be used as interfering specific light.

Moreover, in the above description, the light modulation unit 900 is formed of the three liquid crystal light modulators 400R, 400G, and 400B. Alternatively, the light modulation unit may be formed of two light modulators corresponding to the first light and the second light. In this case, a color image can be formed, for example, by using the yellow light Y from the second light source unit 12 as the second light and providing a color filter in the second light modulator corresponding to the second light. Further, in this case, as the light combining system, the cross-dichroic prism 500 can be replaced, for example, with a prism having only a specific dichroic film having a single-film, continuous film structure.

Further, the above description has been made with reference to the case where the fluorescent member emits red light and green light when excited by blue light, but the fluorescent member is not necessarily configured this way. For example, a fluorescent member that emits three color light fluxes, red light, green light, and blue light when excited by violet or ultraviolet light as the excitation light may be used.

Further, in the above description, the diffuser member 41 is formed on the circular plate 40 rotated by the motor 50, and heat generated in the diffuser plate 41 when it is irradiated with the excitation light is dissipated into a broad area of the circular plate 40 along the direction in which it is rotated, whereby a decrease in light emission efficiency due to the heat generated in the diffuser plate 41 is reduced. When no decrease in light emission efficiency is anticipated, however, no rotating mechanism may be provided but only the diffuser plate 41 may be provided.

Further, the lens integration system using the first lens array 121 and other components may be replaced with a rod integration system using a rod lens.

Further, in the above description, the rotating mechanism 30 includes the circular plate 40, but the plate 40 is not necessarily circular. The circular plate 40 may be replaced with a plate having another contour shape.

The fluorescent member is not necessarily configured as described above. For example, the fluorescent member may be provided on a rotatable circular plate and continuously formed along the direction in which the plate is rotated. Still alternatively, multiple types of fluorescent member may be formed along the direction in which the plate is rotated, so that a plurality of color light fluxes can be successively emitted.

The entire disclosure of Japanese Patent Application No. 2012-099992, filed Apr. 25, 2012 is expressly incorporated by reference herein.

What is claimed is:

1. A projector comprising:
a light source apparatus that includes at least one solid-state light source and outputs illumination light formed of first light that is produced by the at least one solid-state light source and contains specific light as a component and second light that is produced by the at least one solid-state light source but does not contain the specific light as a component;
a light modulation unit including a first light modulator that modulates the first light contained in the illumination light from the light source apparatus in accordance with image information and a second light modulator that modulates the second light contained in the illumination light from the light source apparatus in accordance with image information;
a light combining system that combines modulated light fluxes from the light modulation unit; and
a projection system that projects the combined light from the light combining system as a projected image,
wherein the specific light produced by the at least one solid-state light source is coherent light, and
the light combining system has a specific dichroic film having a single-film, continuous film structure provided in correspondence with the first light.

2. The projector according to claim 1,
wherein the at least one solid-state light source is a laser light source that produces laser light as the specific light.

3. The projector according to claim 1,
wherein in the light combining system, the specific dichroic film reflects the first light and transmits the second light to combine the first light and the second light with each other.

4. The projector according to claim 1,
wherein the light source apparatus outputs third light different from the first and second light as the illumination light,
the projector further comprises a color separation/light guiding system that separates the second light and the third light from each other,
the light modulation unit further includes a third light modulator corresponding to the third light, and
the light combining system is a cross dichroic prism that combines the first, second, and third light modulated by the first, second, and third light modulators, respectively.

5. The projector according to claim 1,
wherein the light source apparatus includes a first light source unit and a second light source unit,
the first light source unit includes a first light source section that produces the specific light and a diffuser member that diffuses the specific light from the first light source section to form the first light within a first wavelength band, and
the second light source unit includes a second light source section that produces excitation light and a fluorescent member that is irradiated with the excitation light from the second light source section and converts the excitation light into fluorescence within a second wavelength band to which at least the second light belongs.

6. The projector according to claim 5,
wherein in the light source apparatus, the first wavelength band is formed of wavelengths shorter than wavelengths in the second wavelength band.

7. The projector according to claim 5,
wherein in the first light source unit, the first wavelength band is a blue light wavelength band, and
in the second light source unit, the second wavelength band is a yellow light wavelength band.

8. The projector according to claim 5,
wherein in the second light source unit, the excitation light is one of blue light, violet light, and ultraviolet light.

9. The projector according to claim 5,
wherein the diffuser member has a first light diffusing portion on a light incident surface side and a second light diffusing portion on a light exiting surface side.
